(19) United States
(12) Patent Application Publication
(10) Pub. No.: US 2007/0266036 A1
(43) Pub. Date: Nov. 15, 2007

(54) Unbounded Redundant Discreet Fact Data Store

(75) Inventors: Chris W. Anderson, Renton, WA (US); Edward David Harris, Bellevue, WA (US); Jamie P. Buckley, Redmond, WA (US); John A. Solaro, Bellevue, WA (US); Larry J. Israel, Bellevue, WA (US); Randall F. Kern, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/383,451

(22) Filed: May 15, 2006

(51) Int. Cl. G06F 7/00

(52) U.S. Cl. 707/100

(57) ABSTRACT

An unbounded redundant discrete fact data store for providing answers to specific fact-based search queries is provided. Facts are stored discretely by the data store with information stored with each discrete fact for locating the discrete fact in response to a search query or browse request. The core of the data store includes subject-indicator-fact sets. Each discrete fact represents a particular facet of a particular subject. Accordingly, the data store includes a subject and zero or more indicators for each discrete fact, facilitating look-up of the discrete facts. Additionally, each subject may have zero or more subject classifications and zero or more parent/child relationships with other subjects, further facilitating filtering and look-up of discrete facts.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Although computer systems can store a wealth of information, it can often be difficult for users to find or retrieve a specific fact or piece of information. For example, users often wish to quickly find specific facts or answers to specific fact-based questions, such as, for instance, “what is the population of China.” A variety of search engines currently exist that allow users to search for information by entering a search input comprising one or more keywords that may be of interest to the user. After receiving a search request from a user, a search engine identifies documents and/or web pages that are relevant based on the keywords. Often, the search engine returns a large number of documents or web page addresses, many of which have little or nothing to do with the specific piece of information that the user was seeking. The user is then left to sift through the list of documents, links, and associated information to find the desired fact. This process can be cumbersome, frustrating, and time consuming, especially when the user is looking for a single specific fact or fact set instead of general information about a given topic.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to an unbounded redundant discrete fact data store. The data store stores discrete facts with information for identifying the appropriate discrete fact for a search query. In particular, for each discrete fact, the data store may include a subject of the discrete fact and zero or more indicators representing zero or more facets of the subject corresponding with the discrete fact, thereby facilitating the look-up of discrete facts based on search queries. Additionally, zero or more subject classifications may be included for the subject of each discrete fact. Further, zero or more parent/child relationships between a discrete fact's subject and one or more other subjects may be included in the data store. The subject classifications and subject parent/child relationships provide relationships between the discrete facts, further facilitating searching across domains of discrete facts.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a diagram showing at least a portion of a data store comprising subject-indicator-fact sets in accordance with an embodiment of the present invention;

FIG. 3 is a diagram showing at least a portion of a data store comprising subject-indicator-fact sets and further including alternatives for subjects and indicators in accordance with an embodiment of the present invention;

FIG. 4 is a diagram of a data structure of at least a portion of a data store having subject-indicator-fact sets and further including subject classifications and parent/child relationships in accordance with an embodiment of the present invention; and

FIG. 5 is a diagram of a data structure of at least a portion of a data store illustrating required parent/child relationships in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to an unbounded redundant discrete fact data store. The data store is structured such that answers are stored individually as discrete facts rather than multiple answers being grouped and stored together as a single entry. Additionally, information required to look-up each discrete fact is stored with each discrete fact. In particular, the core of the data store comprises subject-indicator-fact sets. Each discrete fact represents a particular facet of a particular subject. Accordingly, the data store includes an appropriate subject and indicator (i.e., relevant facet of the subject) for each discrete fact, facilitating the look-up of discrete facts in response to search requests. The data store is further structured such that each subject may have zero or more classifications. Additionally, each subject may have zero or more parent/child relationships with other subjects. As such, subjects may be attached in the data store in a consistent hierarchy. Further, alternatives for subjects, indicators, and classifications may be provided within the data store such that search queries may match more intelligently, flexibly, and safely.

Embodiments of the present invention provide, among other things, a data store that is optimized for scalability and look-up. Additionally, it allows for an unbounded number of discrete facts to be stored. Further, the data store may be redundant in that multiple copies of the data may be stored to ensure a very high degree of availability in the case of scattered hardware failure. The data store provides for the look-up of discrete facts, thereby facilitating the ability to return answers to fact-based questions. By providing subject classifications and subjects in a consistent hierarchy, the data store provides relationships between discrete facts from many different domains. Accordingly, when subjects are correctly classified and attached in a consistent hierarchy in the data store, it becomes possible to search across domains of facts. Further, new facts may be computed based on discrete facts in the data store. While embodiments of the present invention are described herein primarily in the context of searching, further embodiments may support browse or navigation scenarios through subjects with the same classifications or through parent/child relationships.

Accordingly, in one aspect, an embodiment of the invention is directed to one or more computer-readable media having stored thereon a data structure for storing discrete facts and information for identifying one or more discrete facts in response to a search query. The data structure includes a first data field containing data representing a discrete fact. The data structure also includes a second data field containing data representing a subject that corresponds with the discrete fact. The data structure further includes a third data field containing data representing an indicator, the indicator representing a facet of the subject that corresponds with the discrete fact.

In another aspect of the invention, an embodiment is directed to one or more computer-readable media having stored thereon a data structure for storing discrete facts and information for identifying one or more discrete facts in response to a search query. The data structure includes a first data field containing data representing a discrete fact; a second data field containing data representing a subject that corresponds with the discrete fact; a third data field containing data representing an indicator, the indicator representing a facet of the subject that corresponds with the discrete fact; a fourth data field containing data representing one or more classifications for the subject that corresponds with the discrete fact; and a fifth data field containing data representing one or more relationships between the subject that corresponds with the discrete fact and one or more other subjects.

In a further aspect, an embodiment of the invention is directed to one or more computer-readable media having stored thereon a data structure for storing discrete facts and information for identifying one or more discrete facts in response to a search query. The data structure includes a first data field containing data representing a discrete fact; a second data field containing data representing a subject that corresponds with the discrete fact and one or more alternatives for the subject; a third data field containing data representing an indicator and one or more alternatives for the indicator, the indicator and the one or more alternatives for the indicator representing a facet of the subject that correspond with the discrete fact; a fourth data field containing data representing one or more classifications for the subject that corresponds with the discrete fact and one or more alternatives for at least one of the one or more classifications; and a fifth data field containing data representing one or more relationships between the subject that corresponds with the discrete fact and one or more other subjects.

Having briefly described an overview of the present invention, an exemplary operating environment for the present invention is described below.

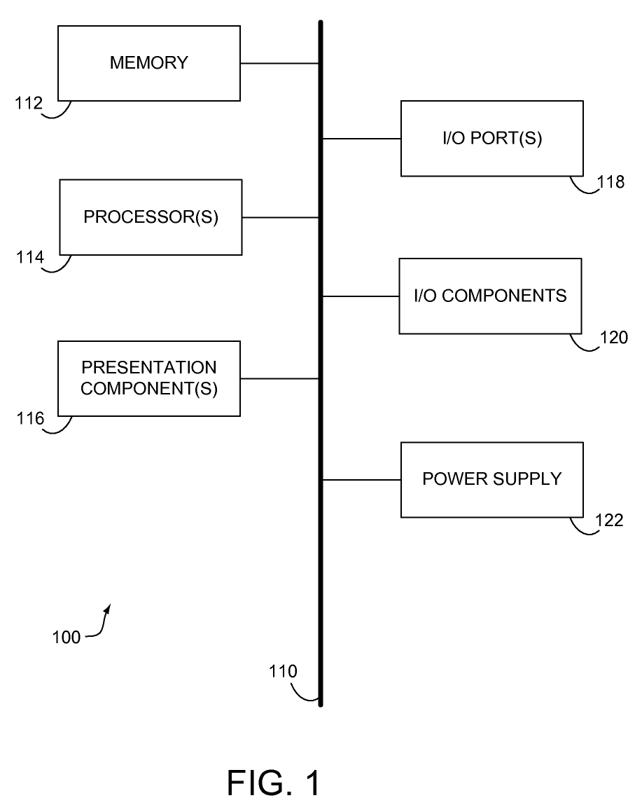

Referring initially to FIG. 1 in particular, an exemplary operating environment for implementing the present invention is shown and designated generally as computing device 100. computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-usable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including 1/0 components 120, some of which may be built in. Illustrative components include a microphone, joystick, game pad, satellite dish, scanner, printer, wireless device, etc.

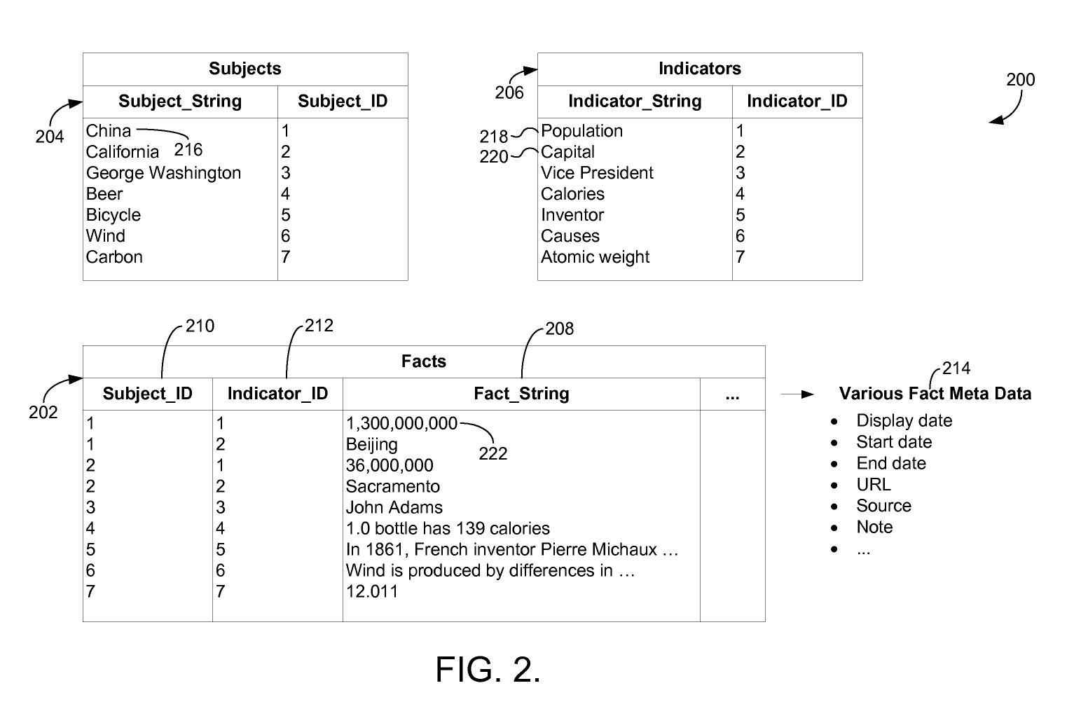

Referring now to FIG. 2, an exemplary data store 200 is illustrated showing a core type of answers data storage as subject-indicator-fact sets. In the data storage shown in FIG. 2, answers are stored as discrete facts, with each fact being represented as a number, a string, a date, or otherwise. Each answer is stored as a discrete fact. Multiple answers are not grouped and stored together as a single fact. In other words, each fact does not contain more than one answer. However, in some embodiments, while answers are stored as discrete facts, multiple facts may grouped by subject (e.g., to converse storage space). By storing each answer as a discrete fact, an answer may be determined by the intersection of a subject and an indicator. FIG. 2 shows a portion of a facts table 202 having a selected number of discrete fact records. Each record in the facts table 202 includes a fact 208, a subject 210, and an indicator 212. Additionally, each record may include a variety of other qualifiers in the form of various other fact meta data 214.

As used herein, the term “subject” represents a person, place, or thing in which a searcher may be interested. For example, FIG. 2 shows a portion of a subjects table 204 that includes the subjects: “China,” “California,” “George Washington,” “Beer,” “Bicycle,” “Wind,” and “Carbon.” Because each subject may have a variety of associated facts, further qualifiers are typically required to determine the appropriate fact for a particular search. In the subject-indicator-fact sets shown in FIG. 2, indicators are provided for further determining which specific fact should be returned for a search. As used herein, the term “indicator” represents the specific facet of a subject in which a searcher may be interested. For example, the subject “China” 216 may have a wide variety of associated facts. As such, indicators are provided to represent specific facets of the subject “China” 216. For instance, facets of “China” 216 may include the total population and the capital, which are represented by the indicators “Population” 218 and “Capital” 220, respectively. A wide variety of other facets of the subject “China” 214 could also be represented by additional indicators. FIG. 2 shows a portion of an indicators table 206 that includes the indicators: “Population,” “Capital,” “Vice President,” “Calories,” “Inventor,” “Causes,” and “Atomic Weight.” As illustrated in FIG. 2, the indicators included in the indicator table 206 are not limited by subject but may be any indicator for any subject.

In operation, the subject-indicator-fact sets may be used to determine answers to search queries. When a user enters a search query, the query may be parsed to determine the relevant subject, indicator, and any other qualifiers for the search. For instance, grammars may be provided for pulling out a subject, indicator, and any other qualifiers from a particular search query. Examples of such grammars are further described in U.S. patent application Ser. No. 11/059,014, filed Feb. 15, 2005, which is herein incorporated by reference in its entirety. The subject, indicator, and any other qualifiers extracted from a query may then be used to search the fact records and return a discrete fact matching the query. For example, a user may provide a search input that includes “what is the population of China.” A grammar may be used to determine that the subject is “China” and the indicator is “population.” Based on this determination, the data store 200 of FIG. 2 may be searched for the intersection of the subject “China” and the indicator “population.” Accordingly, the fact “1,300,000,000” 222 may be determined from the search and returned as an answer to the query.

Other qualifiers beyond a subject and indicator may also be used to filter fact records and determine an appropriate answer for a query. For instance, instead of the previous query input, a user may provide an input that includes “what was the population of China in 1975.” In addition to determining that the subject is “China” and the indicator is “population,” a grammar may determine that the query further includes the qualifier “1975,” which represents a specific date. This qualifier may be used in conjunction with the subject “China” and indicator “population” to determine an appropriate answer. For instance, the facts table 202 may include a number of fact records having the subject “China” and indicator “population.” However, each of these records may include further fact meta data 214, such as a valid date. By matching the qualifier “1975” from the search query to fact meta data 214, the appropriate fact may be retrieved from the facts table 202 and provided as an answer to the query.

While the subject-indicator-fact sets shown in FIG. 2 provide an example of a data store with good functionality, the data store is limited by having only a single subject and only a single indicator for each discrete fact. In particular, the data neglects to take into account that users may employ alternative words for the same subject or indicator. For example, users may enter a number of different alternatives to the subject “China,” such as, for instance, “People's Republic of China” or “PRC.” However, the data store 200 of FIG. 2 fails to include these alternatives. Accordingly, without such alternatives, the data store 200 would fail to provide an answer for a search query, for instance, that includes “what is the population of the People's Republic of China.”

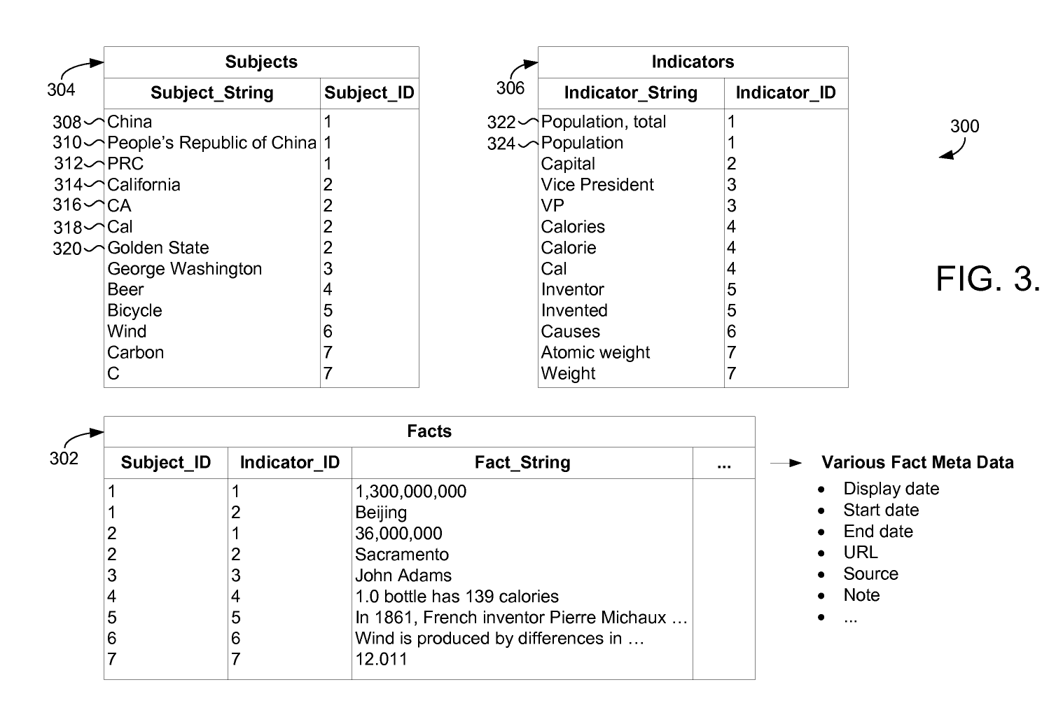

Referring to FIG. 3, an example of a data store 300 with enhanced functionality is illustrated. In particular, the data store 300 takes advantage of alternatives for subjects and indicators. For example, the subjects table 304 in FIG. 3 includes “People's Republic of China” 310 and “PRC” 312 as alternatives for the subject “China” 308. In particular, each of these subject strings represent the same subject. As another example, alternatives for the subject “California” 314 include “CA” 316, “Cal” 318, and “Golden State” 320. Similarly, the indicators table 306 includes alternatives for various indicators. For instance, the indicator “Population, total” 322 has been included as an alternative to the indicator “Population” 324. Obviously, the alternatives shown in the subject table 304 and indicator table 306 in FIG. 3 are provided for illustrative purposes only and a variety of additional alternatives not shown could be included in the data store 300. All such variations are contemplated to be within the scope of embodiments of the present invention.

The facts table 302 in FIG. 3 stays exactly the same as the facts table 200 in FIG. 2. The addition of alternatives for the subjects and indicators allows the same grammars to simply match more intelligently, flexibly, and safely on appropriate subjects and indicators for each discrete fact. For example, the data store 300 allows the same discrete fact to be returned for search inputs including: “what is the population of China;” “what is the total population of China;” “what is the population of the People's Republic of China;” what is the total population of the People's Republic of China;” “what is population of PRC;” and “what is the total population of PRC.”

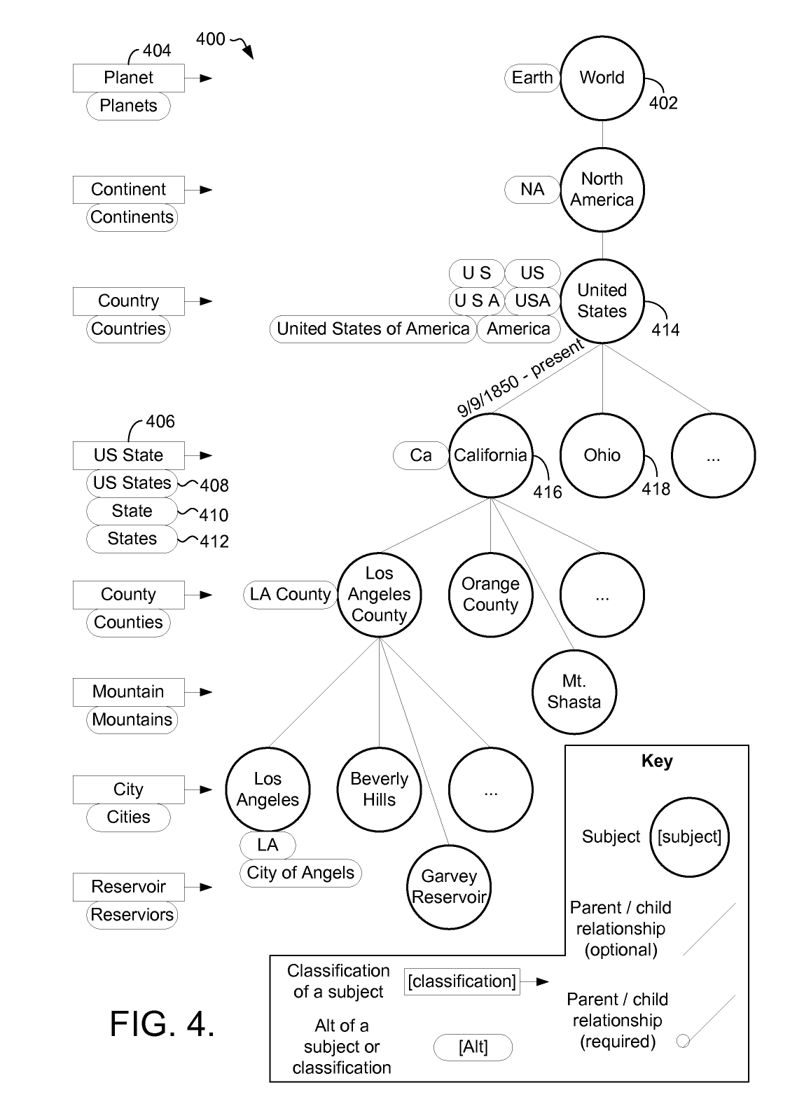

While the data store 300 of FIG. 3 presents enhanced functionality relative to the data store 200 of FIG. 2 by adding alternatives, the data store 300 is still limited in that it may readily provide answers to only simple queries, such as “what is the population of China.” Neither the data store 200 nor the data store 300 is well-adapted to providing answers for more complex queries. FIG. 4 provides an example of an exemplary data structure 400 for a data store providing improved functionality in accordance with an embodiment of the present invention. In particular, the data structure 400 further provides classifications for subjects and parent/child relationships between subjects.

With respect to subject classifications, each subject may have zero, one, or many classifications. For example, the subject “World” 402 has the classification “Planet” 404. Although each subject in FIG. 4 is shown with only one classification, each subject could have multiple classifications. For example, in addition to the classifications shown in FIG. 4, each subject could also have the classification of “Place.”

The addition of subject classifications enhances the data store by providing a mechanism for grouping and sorting facts. In effect, the subject classifications create relationships between discrete facts that allow the data store to search across different domains and readily match answers to more complex search queries. By way of example, a user may provide a search input that includes “what is the state with the largest population.” Based on the input, facts having a subject classified as a “state” may be grouped together and compared to determine which has the largest population.

Similar to the alternatives provided for subjects and indicators in the data store of FIG. 3, the data structure 400 may also include alternatives for each classification. The classification alternatives allows a search query to take advantage of the various alternatives that users may provide as inputs. For instance, the data structure in FIG. 4 shows the classification “US State” 406 having the alternatives “US States” 408, “State” 410, and “States”412. It should be noted that the classification alternatives shown in FIG. 4 are provided for illustrative purposes only, and any number of alternatives may be provided for a particular classification.

In addition to providing classifications for subjects, that data structure shown in FIG. 4 provides parent/child relationships between subjects. Each subject may have zero, one, or many parent/child relationships. In some cases, a subject may have a relationship with multiple child subjects. For instance, as shown in FIG. 4, the subject “United States” 414 is a parent subject for the subjects “California” 416, “Ohio” 418, and so forth. Additionally, a subject may have multiple parent subjects. For example, if a mountain is partly in one state and partly in another, then the mountain could have two parent relationships (i.e., one for each state).

The inclusion of parent/child relationships further enhances the data store by providing another mechanism for sorting and grouping discrete facts. Similar to subject classifications, parent/child relationships effectively create relationships between discrete facts. For example, a user may provide a search input that includes “what is the longest river in Washington.” Based on the input, facts having subjects classified as “rivers” may be filtered by only those having a parent of Washington. Having been filtered thus far, the facts may be compared to provide an appropriate answer to the search query.

In some cases, a parent/child relationship may have a valid date range placed on it to show that the relationship only existed during a certain period. For instance, the parent/child relationship between the subject “United States” 414 and the subject “California” 416 has a date range of “9/9/1850—present” indicating that the relationship is only valid during that time period. A valid date range on parent/child relationships may be useful for determining answers to date-specific search queries. For example, a user may enter a search query that includes “what states were included in the United States in 1820,” in which case the valid date range would preclude California from being included in the answer. Alternatively, a search query that includes “what states were included in the United States in 1860” would result in an answer including California based on the date range for the parent/child relationship.

As described above, subject classifications and parent/child relationships facilitate searches by grouping and creating relationships between discrete facts, thereby allowing the data structure 400 to readily provide answers to more complex search queries. Accordingly, discrete facts may be filtered and compared to provide an answer to a search. Additionally, the data structure allows new facts to be computed based on discrete facts. For example, a user may provide a search input that includes “what is the average GDP of countries in Asia.” The data store may not store the answer to this query as a discrete fact, but may store the GDP of individual countries. Accordingly, based on the search input, the data store may be searched and facts having subjects with the classification “country” and “Asia” as a parent subject may be grouped together. The average GDP may then be calculated based on the relevant discrete facts.

One skilled in the art will recognize that the subjects, parent/child relationships, classifications, and alternatives shown in FIG. 4 are provided for illustrative purposes and are not intended to limit the scope of the present invention. In particular, FIG. 4 merely provides an example of a data structure 400 that may be modeled and taken advantage of in data stores of embodiments of the present invention. For example, although FIG. 4 provides an example using data about places, embodiments may include data structures having any type of discrete facts.

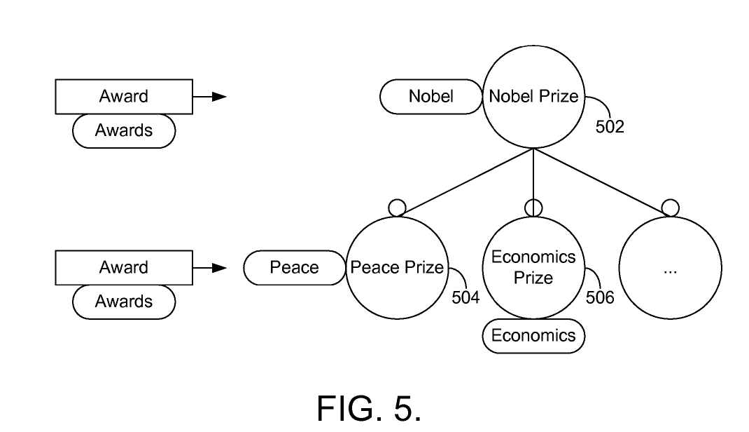

In some embodiments of the present invention, particular parent/child relationships may be defined within the data structure as required relationships, in which both the parent subject and the child subject must be present in the query to be considered a valid subject match on the child subject. Examples of required parent/child relationships may be illustrated in the context of Nobel prizes with reference to FIG. 5. Nobel prizes are awarded annually in a number of different categories, including physics, chemistry, physiology/medicine, literature, peace, and economics. As such, a general question, such as “who won the Nobel prize,” would not include sufficient information for an answer to be determined. Instead, a more specific question, such as “who won the Nobel prize for peace” would be proper. A required parent/child relationship accounts for this aspect that is inherent in certain subjects. For example, in FIG. 5, a required parent/child relationship is shown between the subject “Nobel Prize” 502 and each of the child subjects (i.e., categories of Nobel prizes), “Peace Prize” 504, “Economics Prize” 506, and so forth.

Facts stored by a data store in accordance with embodiments of the present invention may be derived from a variety of different data sources. By way of example only and not limitation, some data may be obtained from feed sources, while other data may be obtained by crawling the Internet. In some cases, the data store may support real-time data (e.g., current stock price quotes, sport statistics for current games, etc.). Because such types of data may be continuously changing, it may not be realistic to store the actual data. Instead, a pointer to the actual data may be provided in the data store as opposed to constantly updating the stored data. When a search query results in a particular fact comprising real-time data, the data may be retrieved at that time based on the pointer in the data store, and the retrieved data may be provided as an answer.

As can be understood, embodiments of the present invention provide an unbounded redundant discrete fact data store that facilitates the look-up of discrete facts in response to search queries. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media having stored thereon a data structure for storing discrete facts and information for identifying one or more discrete facts in response to a search query, the data structure comprising:
a first data field containing data representing a discrete fact;
a second data field containing data representing a subject that corresponds with the discrete fact; and
a third data field containing data representing zero or more indicators, the zero or more indicators representing a facet of the subject that corresponds with the discrete fact.

2. The one or more computer-readable media of claim 1, wherein the second data field further contains data representing one or more alternatives for the subject that corresponds with the discrete fact.

3. The one or more computer-readable media of claim 1, wherein the third data field further contains data representing one or more alternatives for the zero or more indicators.

4. The one or more computer-readable media of claim 1, wherein the discrete fact comprises at least one of a number, a text string, and a date.

5. The one or more computer-readable media of claim 1, wherein the discrete fact comprises a pointer to remotely stored data.

6. The one or more computer-readable media of claim 1, further comprising a fourth data field containing data representing one or more classifications for the subject that corresponds with the discrete fact.

7. The one or more computer-readable media of claim 6, wherein the fourth data field further comprises one or more alternatives for at least one of the one or more classifications for the subject that corresponds with the discrete fact.

8. The one or more computer-readable media of claim 1, further comprising a fifth data field containing data representing one or more relationships between the subject that corresponds with the discrete fact and one or more other subjects.

9. The one or more computer-readable media of claim 8, wherein the fifth data field further comprises data representing a valid date range for at least one of the one or more relationships between the subject that corresponds with the discrete fact and the one or more other subjects.

10. The one or more computer-readable media of claim 8, wherein the fifth data field further comprises data indicating that at least one of the one or more relationships between the subject that corresponds with the discrete fact and the one or more other subjects is a required relationship.

11. The one or more computer-readable media of claim 8, wherein the fifth data field further comprises data representing one or more other relationships between at least one of the one or more other subjects and one or more further subjects.

12. The one or more computer-readable media of claim 8, wherein the fifth data field further comprises data representing a plurality of parent/child relationships among the subject that corresponds with the discrete fact, the one or more other subjects, and one or more further subjects.

13. One or more computer-readable media having stored thereon a data structure for storing discrete facts and information for identifying one or more discrete facts in response to a search query, the data structure comprising:
a first data field containing data representing a discrete fact;
a second data field containing data representing a subject that corresponds with the discrete fact;
a third data field containing data representing an indicator, the indicator representing a facet of the subject that corresponds with the discrete fact;
a fourth data field containing data representing one or more classifications for the subject that corresponds with the discrete fact; and
a fifth data field containing data representing one or more relationships between the subject that corresponds with the discrete fact and one or more other subjects.

14. The one or more computer-readable media of claim 13, wherein the second data field further contains data representing one or more alternatives for the subject that corresponds with the discrete fact.

15. The one or more computer-readable media of claim 13, wherein the third data field further contains data representing one or more alternatives for the indicator.

16. The one or more computer-readable media of claim 13, wherein the discrete fact comprises at least one of a number, a text string, and a date.

17. The one or more computer-readable media of claim 13, wherein the discrete fact comprises a pointer to remotely stored data.

18. One or more computer-readable media having stored thereon a data structure for storing discrete facts and information for identifying one or more discrete facts in response to a search query, the data structure comprising:
a first data field containing data representing a discrete fact;
a second data field containing data representing a subject that corresponds with the discrete fact and one or more alternatives for the subject;
a third data field containing data representing an indicator and one or more alternatives for the indicator, the indicator and the one or more alternatives for the indicator representing a facet of the subject that correspond with the discrete fact;
a fourth data field containing data representing one or more classifications for the subject that corresponds with the discrete fact and one or more alternatives for at least one of the one or more classifications; and
a fifth data field containing data representing one or more relationships between the subject that corresponds with the discrete fact and one or more other subjects.

19. The one or more computer-readable media of claim 18, wherein the discrete fact comprises at least one of a number, a text string, and a date.

20. The one or more computer-readable media of claim 18, wherein the discrete fact comprises a pointer to remotely stored data.
